(19) United States
(12) Patent Application Publication
(10) Pub. No.: US 2015/0244222 A1
(43) Pub. Date: Aug. 27, 2015

(54) ACTIVE ASSEMBLY OF A WIND TURBINE ROTATING ELECTRIC MACHINE

(71) Applicant: WILIC S.AR.L., Luxembourg (LU)

(72) Inventor: Mattia Scuotto, Vipiteno (IT)

(21) Appl. No.: 14/427,959

(22) PCT Filed: Sep. 20, 2013
(86) PCT No.: PCT/IB2013/058713

§ 371 Date: Mar. 12, 2015

(30) Foreign Application Priority Data
Sep. 20, 2012 (IT) MI2012A001568

(51) Int. Cl. H02K 3/18; F03D 9/00

(52) U.S. Cl. CPC H02K 3/18; F03D 9/002

(57) ABSTRACT

An active assembly of a wind turbine rotating electric machine has a magnetic guide having at least two slots separated by a tooth with a plane of symmetry; and a coil formed by a plurality of electric conductors, each with a substantially rectangular cross section and wound repeatedly about the tooth to fill the slots and form two heads close to the opposite ends of the tooth; the width of each electric conductor being less than a third of the distance between the electric conductor and the plane of symmetry.

### PRIORITY CLAIM

This application is a national stage application of PCT/IB2013/058713, filed on Sep. 20, 2013, which claims the benefit of and priority to Italian Patent Application No. MI2012A 001568, filed on Sep. 20, 2012, the entire contents of which are each incorporated by reference herein.

### BACKGROUND

Certain known wind turbines employ rotating electric machines of the type in which a rotor rotates about an axis of rotation with respect to a stator. The rotor and the stator comprise respective, supporting structures; such as tubular supporting structures and respective tubular active parts concentric with and facing one another, and fitted to the respective supporting structures. The active parts are separated by an air gap, which should be constant and relatively very small to optimize the efficiency of the rotating electric machine.

In this field, segmented active parts, (i.e., active parts divided into a plurality of axial active segments) are employed to enable relatively easy assembly, removal, and maintenance of the active parts of the rotating electric machine, which is mounted tens of metres off the ground. Each active segment can be removed and, if necessary, replaced with a new one relatively easily. The tubular active parts are secured to the respective supporting structures, which have respective mating faces for the active segments, and axial grooves configured to guide and possibly fix the respective active segments in position. The active segments of the stator normally have one or more active assemblies, by which is meant an assembly comprising a magnetic guide with at least two slots separated by a tooth; and a coil made of electric conductors and wound to fill the slots and form two heads close to the opposite ends of the tooth.

The efficiency of the electric machine depends on the extent to which the slots on each active assembly are filled. Some examples are given in U.S. Published Patent Application No. 2011/00210558 and U.S. Pat. No. 4,617,725.

Moreover, to reduce magnetic flux losses, and to reduce the size of the ends of the segments and so make the segments easier to handle, the heads of the coils must project as little as possible from the magnetic guide.

### SUMMARY

The present disclosure relates to an active assembly of a wind turbine rotating electric machine.

It is an advantage of the present disclosure to provide an active assembly configured to optimize electric efficiency and easy handling.

According to the present disclosure, there is provided an active assembly of a wind turbine rotating electric machine, the active assembly comprising a magnetic guide having two slots separated by a tooth with a plane of symmetry; and a plurality of electric conductors, each with a substantially rectangular cross section and wound edgewise about the tooth to fill the slots and form two heads close to the opposite ends of the tooth, each head comprising a plurality of adjacent U-shaped turns of the electric conductors; and wherein the width of each electric conductor is less than a third of the distance between the electric conductor and the plane of symmetry of the tooth.

Because of the rectangular cross section of the electric conductors, the slots can be filled relatively evenly, and the electric conductors can all be folded into a U to form compact, relatively closely-packed heads. Accordingly, by providing the geometric as described herein, the electric conductor may be folded edgewise without damaging the electric conductor.

In certain embodiments of the present disclosure, all the electric conductors inside the slots are the same width. This solution has the advantage of, in certain embodiments, employing only one type of electric conductor.

In certain embodiments, the width of each slot substantially equals a whole multiple of the width of the electric conductors. The size of the slot is based on the size of the electric conductors.

In an alternative embodiment of the present disclosure, some of said electric conductors are of different widths; the electric conductors of larger width being located further from the plane of symmetry of the tooth than the electric conductors of smaller width. This technical solution reduces the number or quantity of electric conductors needed to fill the slot. Reducing the number or quantity of conductors improves the efficiency of the rotating electric machine by reducing the space occupied by the electric conductor insulation, and the voids formed by the rounded corners of the rectangular cross section of the electric conductor.

In certain embodiments, the respective widths of the electric conductors increase as a function of the distance between the electric conductors and the plane of symmetry of the tooth.

The conductor furthest from the plane of symmetry may be much wider than the one closest to the plane of symmetry. In certain embodiments, the width increases linearly with the distance from the plane of symmetry of the tooth. In this configuration, the width of the slot substantially equals the sum of the widths of all the electric conductors.

The present disclosure also relates to an active segment.

According to the present disclosure, there is provided a wind turbine rotating electric machine active segment comprising at least one active assembly as defined above.

The present disclosure also relates to a wind turbine rotating electric machine.

According to the present disclosure, there is provided a wind turbine rotating electric machine; the rotating electric machine being a synchronous, permanent-magnet type, and comprising a stator, and a rotor which rotates about an axis of rotation about the stator; the stator comprising a tubular supporting structure, a tubular active part fitted to the supporting structure, and a plurality of active assemblies arranged uniformly about the axis of rotation to form said active part, and as defined above; and the rotor comprising a further tubular supporting structure, and a further tubular active part fitted to the further supporting structure.

The rotating electric machine is thus relatively highly efficient and relatively easy to maintain.

The present disclosure also relates to a wind turbine configured to produce electric energy.

According to the present disclosure, there is provided a wind turbine configured to produce electric energy; the wind turbine comprising a vertical structure and a main frame configured to support in an elevated position a rotating electric machine as defined above.

Additional features and advantages are described in, and will be apparent from the following Detailed Description and the figures.

### BRIEF DESCRIPTION OF THE DRAWINGS

A number of non-limiting embodiments of the present disclosure will be described by way of example with reference to the attached drawings, in which:

FIG. 1 shows a partly sectioned side view, with parts removed for clarity, of a wind turbine to which the present disclosure may advantageously be applied;

FIG. 2 shows a larger-scale cross section, with parts removed for clarity, of a rotating electric machine of the FIG. 1 wind turbine and comprising active assemblies in accordance with the present disclosure;

FIG. 3 shows a larger-scale, partly sectioned view in perspective, with parts removed for clarity, of an electric conductor of the FIG. 2 active assemblies;

FIG. 4 shows a partly sectioned plan view, with parts removed for clarity, of an active assembly in accordance with the present disclosure;

FIG. 5 shows a larger-scale cross section, with parts removed for clarity, of a detail of the FIG. 4 active assembly;

FIG. 6 shows a partly sectioned plan view, with parts removed for clarity, of an active assembly in accordance with a further embodiment of the present disclosure; and

FIG. 7 shows a larger-scale cross section, with parts removed for clarity, of the FIG. 6 active assembly.

### DETAILED DESCRIPTION

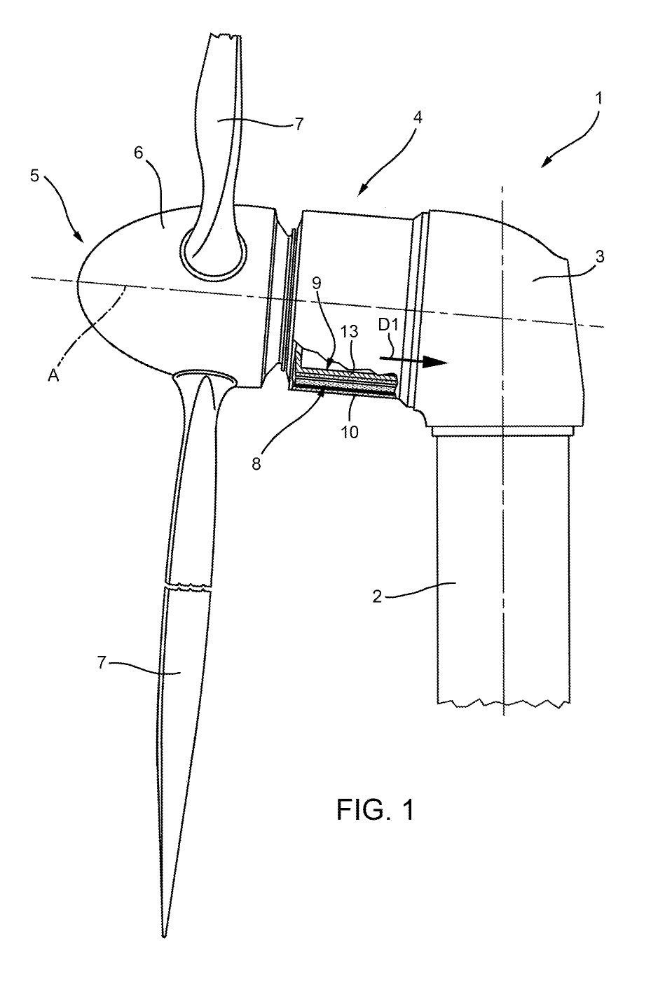

Referring now to the example embodiments of the present disclosure illustrated in FIGS. 1 to 7, number 1 in FIG. 1 indicates as a whole a wind turbine configured to produce electric energy. Wind turbine 1 is a direct-drive type. In the example shown, wind turbine 1 comprises a vertical structure 2; a main frame 3 fitted in rotary manner to the top of vertical structure 2; a rotating electric machine 4; and a blade assembly 5 which rotates about an axis of rotation A. Rotating electric machine 4 is located between main frame 3 and blade assembly 5, and, in addition to producing electric energy, also serves to support blade assembly 5 and to transmit forces and moments induced by blade assembly 5 and rotating electric machine 4 to main frame 3.

In the example shown, main frame 3 is defined by a curved, tubular nacelle.

Blade assembly 5 comprises a hollow hub 6 connected to rotating electric machine 4; and a plurality of blades 7.

Rotating electric machine 4 extends about axis of rotation A, and is substantially tubular to form a passage between the hollow main frame 3 and hollow hub 6. Rotating electric machine 4 comprises a stator 8; and a rotor 9 located inside stator 8, and which rotates with respect to stator 8 about axis of rotation A.

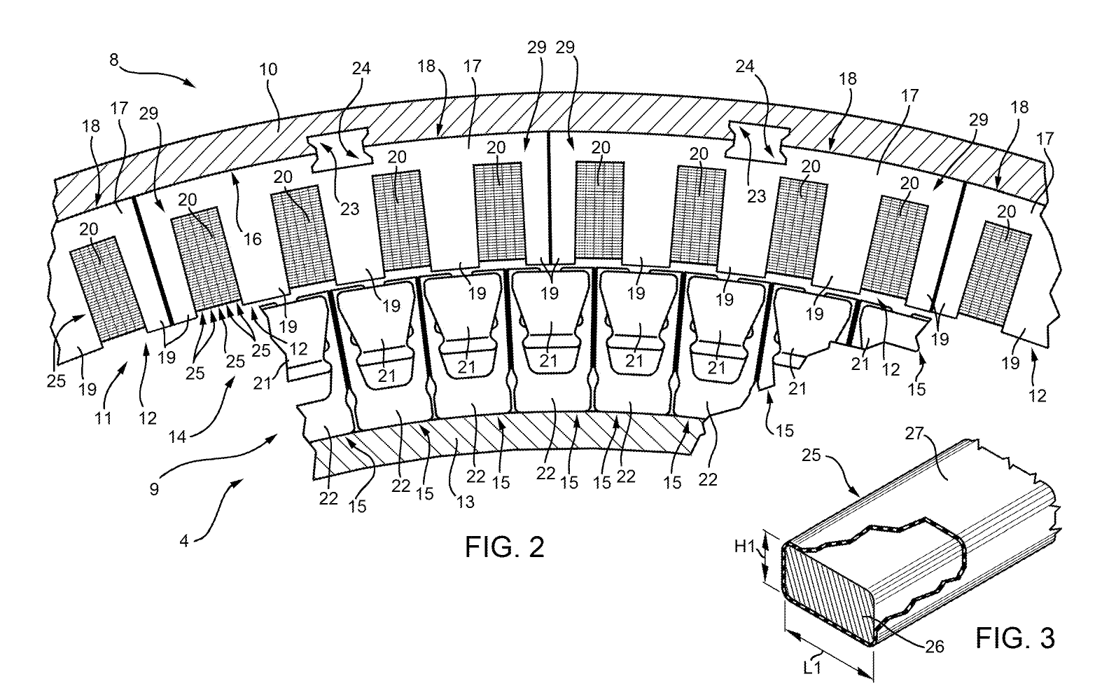

With reference to FIG. 2, stator 8 comprises a tubular supporting structure 10; and a tubular active part 11 comprising a plurality of axial active segments 12. Similarly, rotor 9 comprises a tubular supporting structure 13; and a tubular active part 14 comprising a plurality of axial active segments 15. As shown in FIG. 1, supporting structure 10 is connected to main frame 3, and supporting structure 13 is connected to blade assembly 5.

Supporting structure 10 has a mating face 16—in the example shown, a cylindrical mating face—along which active segments 12 rest. In the example shown, each active segment 12 comprises a lamination pack 17, which is substantially prismatic in shape, extends mainly axially, and has a mating face 18 configured to rest on mating face 16, and a plurality of teeth 19 projecting on the opposite side to mating face 18; and a plurality of coils 20 wound about teeth 19 to define field poles.

More specifically, each segment 15 comprises an assembly 21 of magnetic guides and permanent magnets; and a gripper 22 configured to grip assembly 21. Gripper 22 is positioned resting on and fixed to tubular structure 13.

The system configured to lock segments 12 is configured to fix each segment 12 to tubular structure 10 independently of the other segments 12. Accordingly, supporting structure 10 has a plurality of grooves 23, which extend inside the body of supporting structure 10, along mating face 16. Grooves 23 themselves define locks configured to lock active segments 12, and cooperate with further locks (not shown) configured to cooperate with grooves 23.

In the example shown, supporting structure 10 has a number or quantity of grooves 23 equal to the number or quantity of segments 12. And each segment 12 has a groove 24 configured to face and communicate with a respective groove 23.

Each coil 20 is defined by a plurality of electric conductors 25, each wound about a tooth 19. In the FIG. 3 example, five conductors 25 are wound about tooth 19.

Active segments 12 and 15 are removable selectively from rotating electric machine 4 in a direction D1, and are insertable selectively onto rotating electric machine 4 in the opposite direction to direction D1.

With reference to FIG. 3, each conductor 25 has a substantially rectangular cross section, a width L1 (long side), and a height H1 (short side). It should be appreciated that the cross section of electric conductor 25 differs slightly from a rectangle by having rounded corners. Each conductor 25 comprises a metal core 26, and an insulating sheath 27 covering metal core 26. Electric conductor 25 is particularly rigid, and can be deformed permanently lengthwise into various shapes. Electric conductor 25, with the technical characteristics described, are normally referred to as a ‘flat’ because of its flat shape.

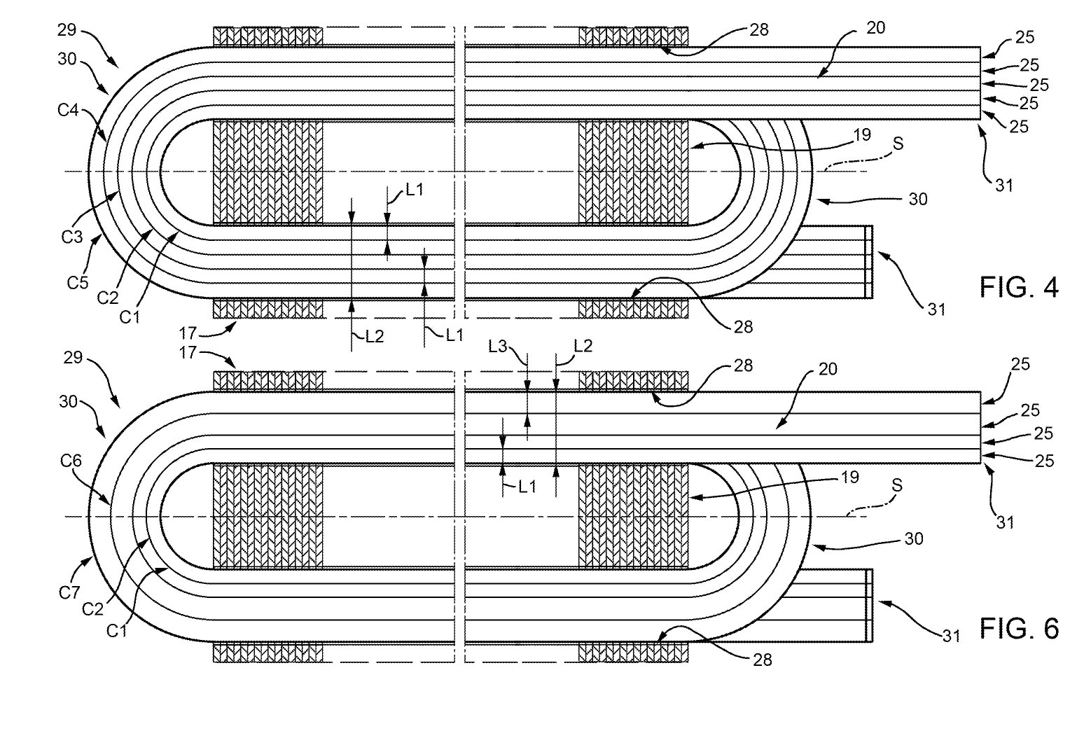

With reference to FIG. 4, the assembly defined by the portion of lamination pack 17 with a tooth 19 and two slots 28 on opposite sides of tooth 19, and by a coil 20 wound about tooth 19, is referred to as active assembly 29. In addition to two parallel portions housed inside slots 28, coil 20 also comprises two heads 30 at opposite ends of tooth 19, and two connecting ends 31.

Electric conductors 25 are folded edgewise about tooth 19 at heads 30. More specifically, electric conductors 25 are wound about tooth 19 in a pattern of concentric spirals or similar spirals. In other words, a first electric conductor 25 is wound directly about a tooth 19 along a first spiral path; and a second electric conductor 25 is wound directly about the first electric conductor 25 along a second spiral path. The other electric conductors 25 are wound in further patterns similar to those of the first and second electric conductor 25. And, depending on the location of electric conductors 25 inside slots 28, electric conductors 25 define turns C1, C2, C3, C4, C5, which increase in radius of curvature from tooth 19.

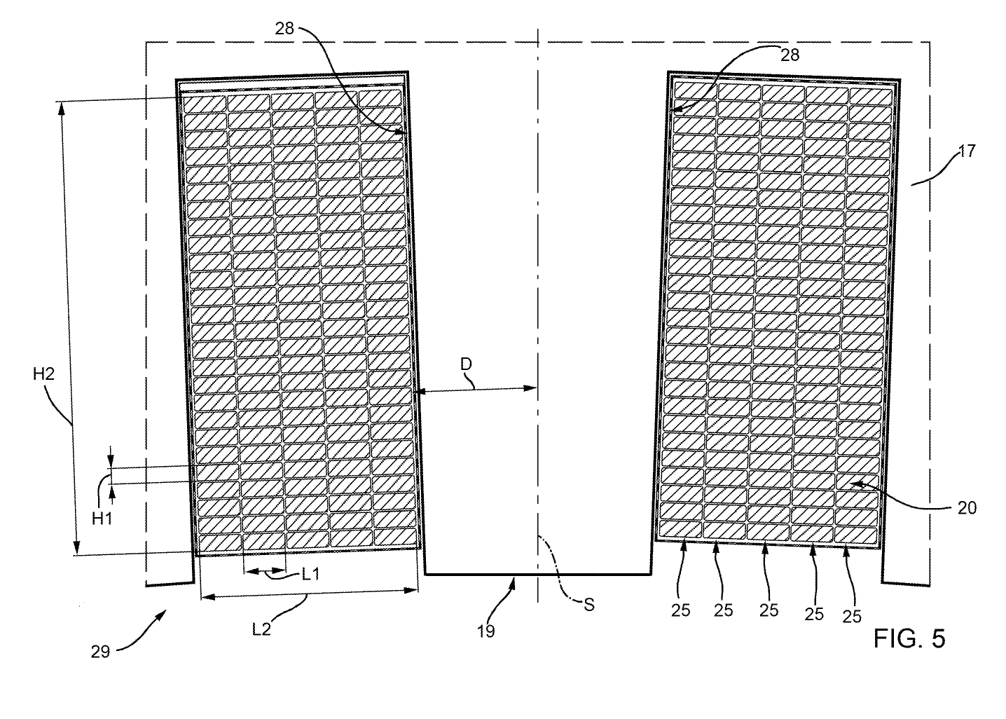

With reference to FIG. 5, each tooth 19 has a plane of symmetry S, which substantially also defines the plane of symmetry of coil 20. In the example shown, the width L2 of slots 28 substantially equals a whole multiple of the width L1 of electric conductors 25; or conversely, the width L1 of electric conductors 25 substantially equals a submultiple of the width L2 of slots 28. The width L1 of the electric conductor is selected so that it is less than a third of the distance D between electric conductor 25 and the plane of symmetry S of tooth 19.

With reference to FIG. 4, conformance with the above condition enables electric conductor 25 to be folded edgewise to form turn C1 and, consequently, also turns C2, C3, C4 C5 at heads 30 without damaging metal core 26 or insulating sheath 27 of electric conductor 25 (FIG. 3).

In the example shown, for the sake of simplicity and component part standardization, electric conductors 25 are all of the same width L1 and the same size in general. This way, turns C1, C2, C3 C4, C5 are all U-shaped, and the resulting heads 30 are closely-packed and compact with very little jut-out.

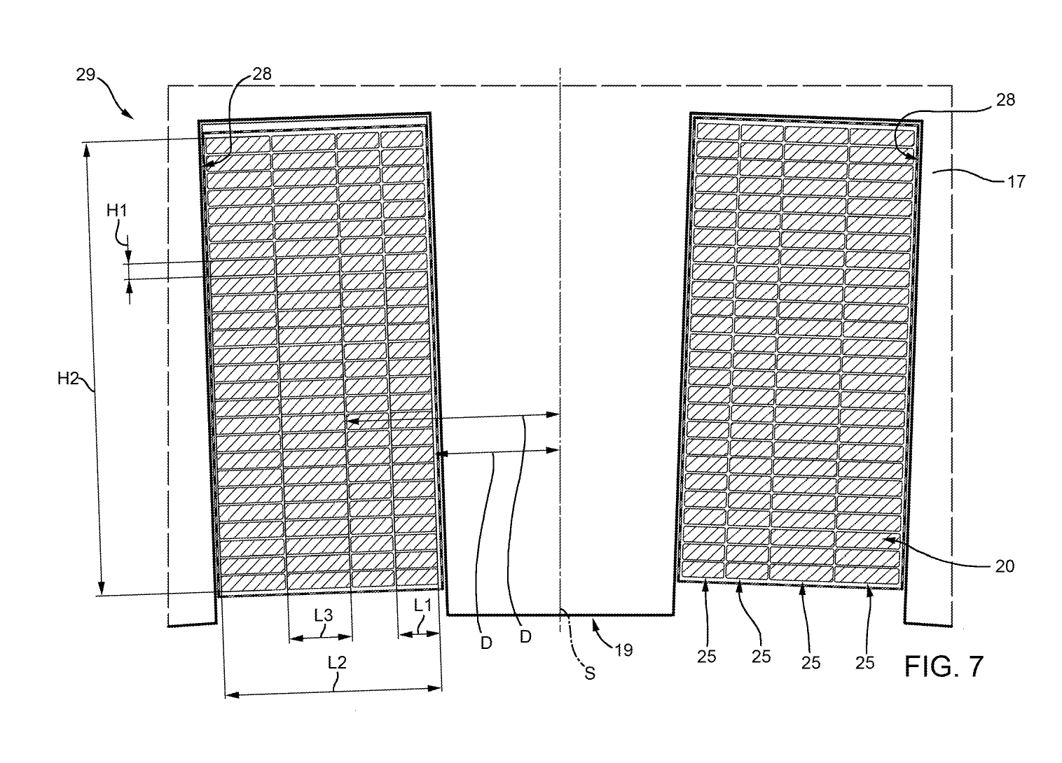

With reference to FIGS. 6 and 7, an embodiment of the present disclosure employs electric conductors 25 of the same height H1, but different widths L1 and L3, where L3 is greater than L1.

Basically, the principle employed is to use electric conductors 25 increasing in width with the distance D from the plane of symmetry S of tooth 19. This way, slot 28 is filled with fewer electric conductors 25—in the example shown, four as opposed to the five conductors in FIGS. 4 and 5.

With reference to FIG. 6, the four electric conductors 25 form, at heads 30 and working outwards of tooth 19, four turns C1, C2, C6, C7 of increasing radius of curvature. It should be appreciated that the increasing width of electric conductor 25 as a function of the distance from tooth 19 is not essential to the present disclosure.

Clearly, changes may be made to the active assembly according to the present disclosure without, however, departing from the protective scope of the accompanying Claims. That is, various changes and modifications to the presently disclosed embodiments will be apparent to those skilled in the art. Such changes and modifications can be made without departing from the spirit and scope of the present subject matter and without diminishing its intended advantages. It is therefore intended that such changes and modifications be covered by the appended claims.

1-11. (canceled)

12. A wind turbine rotating electric machine active assembly comprising:
a magnetic guide defining two slots separated by a tooth having a plane of symmetry; and
a plurality of electric conductors, each electric conductor with a substantially rectangular cross section and wound edgewise repeatedly about the tooth to at least partly fill the two slots and to form two heads at designated distances to opposite ends of the tooth, each formed head including a plurality of adjacent U-shaped turns of the electric conductors, wherein a width of each electric conductor is less than a third of a distance between the electric conductor and the plane of symmetry of the tooth.

13. The wind turbine rotating electric machine active assembly of claim 12, wherein all the electric conductors inside the two slots are the same width.

14. The wind turbine rotating electric machine active assembly of claim 12, wherein the width of each slot is substantially equal to a whole multiple of the width of the electric conductors.

15. The wind turbine rotating electric machine active assembly of claim 12, wherein at least two of said electric conductors are of different widths, and the at least one electric conductor of larger width is located further from the plane of symmetry of the tooth than the at least one electric conductor of smaller width.

16. The wind turbine rotating electric machine active assembly of claim 15, wherein the respective widths of the at least two of the electric conductors increase as a function of a distance between the at least two of the electric conductors and the plane of symmetry of the tooth.

17. The wind turbine rotating electric machine active assembly of claim 15, wherein the width of each slot is substantially equal to a sum of the widths of all of the electric conductors inside the slot.

18. The wind turbine rotating electric machine active assembly of claim 12, wherein each electric conductor has a metal core, and an insulating sheath covering the metal core.

19. A wind turbine rotating electric machine active segment comprising:
at least one active assembly including:
a magnetic guide defining two slots separated by a tooth having a plane of symmetry, and
a plurality of electric conductors, each electric conductor with a substantially rectangular cross section and wound edgewise repeatedly about the tooth to at least partly fill the two slots and to form two heads at designated distances to opposite ends of the tooth, each formed head including a plurality of adjacent U-shaped turns of the electric conductors, wherein a width of each electric conductor is less than a third of a distance between the electric conductor and the plane of symmetry of the tooth.

20. The wind turbine rotating electric machine active segment of claim 19, which includes:
a mating face on an opposite side to the tooth; and
a locking member located along the mating face.

21. A synchronous, permanent-magnet type wind turbine rotating electric machine comprising:
a stator including:
a stator tubular supporting structure,
a stator tubular active part fitted to the supporting structure, and
a plurality of active assemblies arranged about an axis of rotation to form tubular active part, each active assembly including:
a magnetic guide defining two slots separated by a tooth having a plane of symmetry, and
a plurality of electric conductors, each electric conductor with a substantially rectangular cross section and wound edgewise repeatedly about the tooth to at least partly fill the two slots and to form two heads at designated distances to opposite ends of the tooth, each formed head including a plurality of adjacent U-shaped turns of the electric conductors, wherein a width of each electric conductor is less than a third of a distance between the electric conductor and the plane of symmetry of the tooth, and
a rotor which rotates about the axis of rotation about the stator, the rotor including:
a rotor tubular supporting structure, and
a rotor tubular active part fitted to the rotor supporting structure.

22. An electric energy producing wind turbine comprising:
a vertical structure;
a main frame and
a rotating electric machine supported, in an elevated position, by the main frame, said rotating electric machine including:
a stator including:
a stator tubular supporting structure,
a stator tubular active part fitted to the supporting structure, and
a plurality of active assemblies arranged about an axis of rotation to form tubular active part, each active assembly including:
a magnetic guide defining two slots separated by a tooth having a plane of symmetry, and
a plurality of electric conductors, each electric conductor with a substantially rectangular cross section and wound edgewise repeatedly about the tooth to at least partly fill the two slots and to form two heads at designated distances to opposite ends of the tooth, each formed head including a plurality of adjacent U-shaped turns of the electric conductors, wherein a width of each electric conductor is less than a third of a distance between the electric conductor and the plane of symmetry of the tooth, and
a rotor which rotates about the axis of rotation about the stator, the rotor including:
a rotor tubular supporting structure, and
a rotor tubular active part fitted to the rotor supporting structure.
